(19) United States
(12) Patent Application Publication
(10) Pub. No.: US 2024/0234014 A9
(43) Pub. Date: Jul. 11, 2024

(54) COIL COMPONENT

(71) Applicant: TDK CORPORATION, Tokyo (JP)

(72) Inventors: So KOBAYASHI, Tokyo (JP); Youichi KAZUTA, Tokyo (JP); Yuto SHIGA, Tokyo (JP); Yuichi TAKUBO, Tokyo (JP); Xuran GUO, Tokyo (JP); Toru YAGINUMA, Tokyo (JP)

(73) Assignee: TDK CORPORATION, Tokyo (JP)

(21) Appl. No.: 18/361,370

(22) Filed: Jul. 28, 2023

(30) Foreign Application Priority Data
Oct. 24, 2022 (JP) 2022-170057

(51) Int. Cl. H01F 27/29; H01F 17/00

(52) U.S. Cl. CPC H01F 27/292; H01F 17/0013

(57) ABSTRACT

A coil component includes an element body, a coil, a first terminal electrode, and a second terminal electrode. The coil has a coil axis extending in a direction in which a pair of side surfaces face each other. The first terminal electrode and the second terminal electrode have first electrode portions exposed on end surfaces and second electrode portions exposed on a main surface, respectively, and are not exposed on each of the pair of side surfaces. In a direction in which a pair of main surfaces face each other, a distance between each of ends of the first electrode portions on the main surface side and the main surface is larger than a distance between a top portion of the coil closest to the main surface and the main surface.

### TECHNICAL FIELD

The present disclosure relates to a coil component.

### BACKGROUND

Patent Literature 1 (Japanese Unexamined Patent Publication No. 2017-73536) discloses a coil component including an element body, a coil arranged in the element body, and a pair of terminal electrodes arranged in the element body.

### SUMMARY

It is an object of one aspect of the present disclosure to provide a coil component in which the peeling of a terminal electrode from an element body can be suppressed.

A coil component according to one aspect of the present disclosure includes: an element body having a pair of end surfaces facing each other, a pair of main surfaces facing each other, and a pair of side surfaces facing each other, one of the main surfaces being a mounting surface; a coil arranged in the element body and formed by a plurality of coil conductors; and a pair of terminal electrodes electrically connected to the coil. The coil has a coil axis extending in a direction in which the pair of side surfaces face each other. Each of the pair of terminal electrodes has a first electrode portion exposed on the end surface and a second electrode portion connected to an end of the first electrode portion on a side of the mounting surface and exposed on the mounting surface, and is not exposed on each of the pair of side surfaces. In a direction in which the pair of main surfaces face each other, a distance between the mounting surface and an end of at least a part of the first electrode portion on a side of the other main surface is larger than a distance between the mounting surface and a top portion of the coil closest to the other main surface.

In the coil component according to one aspect of the present disclosure, in the direction in which the pair of main surfaces face each other, the distance between the mounting surface and the end of at least a part of the first electrode portion on the side of the other main surface is larger than the distance between the mounting surface and the top portion of the coil closest to the other main surface. Therefore, in the coil component, the contact area between the element body and the terminal electrode can be increased. For this reason, in the coil component, the bonding strength between the element body and the terminal electrode can be improved. Therefore, in the coil component, the peeling of the terminal electrode from the element body can be suppressed. As a result, it is possible to suppress deterioration in the reliability of the coil component.

In one embodiment, each of the pair of terminal electrodes may have a third electrode portion that is connected to an end of the first electrode portion on the other main surface side and is arranged so as to face the second electrode portion in the direction in which the pair of main surfaces face each other. With this configuration, the contact area between the element body and the terminal electrode can be further increased. For this reason, in the coil component, the bonding strength between the element body and the terminal electrode can be further improved. Therefore, in the coil component, the peeling of the terminal electrode from the element body can be suppressed.

In one embodiment, a thickness of the terminal electrode when viewed from the direction in which the pair of side surfaces face each other may be equal to or less than a width of each of the plurality of coil conductors. With this configuration, the volume of the terminal electrode can be reduced. Therefore, in the process for manufacturing a coil component, it is possible to suppress the occurrence of cracks in the element body due to the difference in thermal contraction rate between the element body and the terminal electrode.

In one embodiment, the coil and the first electrode portion may be connected to each other by a connection portion, and a width of the connection portion may be equal to or greater than a width of each of the plurality of coil conductors. With this configuration, it is possible to improve the bonding strength between the terminal electrode and the connection portion. Therefore, in the coil component, the peeling of the terminal electrode from the element body can be suppressed.

In one embodiment, the coil may have a circular outer shape when viewed from the direction in which the pair of side surfaces face each other. With this configuration, the distance between the terminal electrode and the coil can be secured. Therefore, in the coil component, it is possible to reduce the stray capacitance generated between the terminal electrode and the coil.

According to one aspect of the present disclosure, it is possible to suppress the peeling of the terminal electrode from the element body.

### BRIEF DESCRIPTION OF THE DRAWINGS

FIG. 1 is a perspective view of a coil component according to a first embodiment.

FIG. 2 is a side view of the coil component shown in FIG. 1.

FIG. 3 is an exploded perspective view of the coil component.

FIG. 4 is a perspective view of a coil component according to a second embodiment.

FIG. 5 is a side view of the coil component shown in FIG. 4.

FIG. 6 is a perspective view of a coil component according to a third embodiment.

FIG. 7 is a side view of the coil component shown in FIG. 6.

FIG. 8 is an end view of a coil component according to another embodiment.

### DETAILED DESCRIPTION

Hereinafter, preferred embodiments of the present disclosure will be described in detail with reference to the accompanying diagrams. In addition, in the description of the diagrams, the same or equivalent elements are denoted by the same reference numerals, and repeated description thereof will be omitted.

### First Embodiment

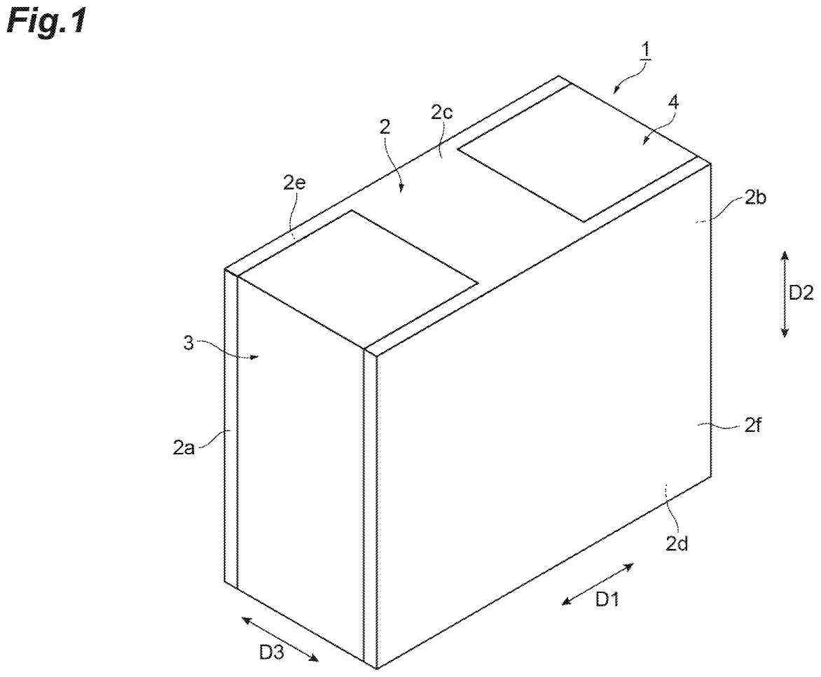

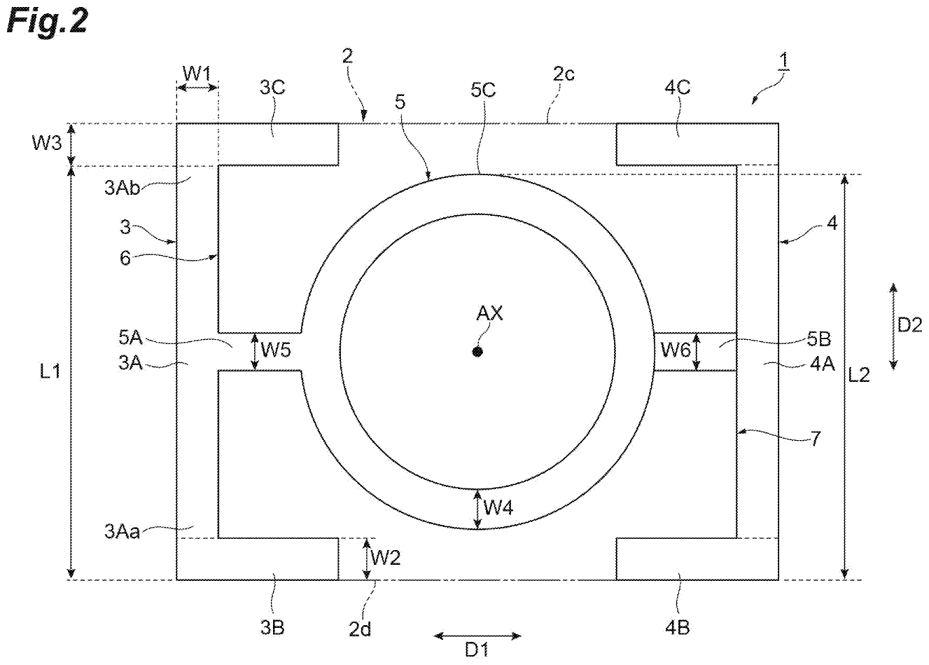

A coil component according to a first embodiment will be described with reference to FIGS. 1 and 2. FIG. 1 is a perspective view of the coil component according to the first embodiment. FIG. 2 is a side view of the coil component shown in FIG. 1. In FIG. 2, an element body is indicated by a two-dot chain line.

As shown in FIGS. 1 and 2, a coil component 1 includes an element body 2, a first terminal electrode 3, a second terminal electrode 4, and a coil 5.

The element body 2 has a rectangular parallelepiped shape. Examples of the rectangular parallelepiped shape include a rectangular parallelepiped shape with chamfered corners and ridges and a rectangular parallelepiped shape with rounded corners and ridges. The element body 2 has, as outer surfaces, a pair of end surfaces 2a and 2b, a pair of main surfaces 2c and 2d, and a pair of side surfaces 2e and 2f. The end surfaces 2a and 2b face each other. The main surfaces 2c and 2d face each other. The side surfaces 2e and 2f face each other. Hereinafter, it is assumed that a direction in which the end surfaces 2a and 2b face each other is a first direction D1, a direction in which the main surfaces 2c and 2d face each other is a second direction D2, and a direction in which the side surfaces 2e and 2f face each other is a third direction D3. The first direction D1, the second direction D2, and the third direction D3 are approximately perpendicular to each other. The end surfaces 2a and 2b extend in the second direction D2 so

as to connect the main surfaces 2c and 2d to each other. The end surfaces 2a and 2b also extend in the third direction D3 so as to connect the side surfaces 2e and 2f to each other. The main surfaces 2c and 2d extend in the first direction D1 so as to connect the end surfaces 2a and 2b to each other. The main surfaces 2c and 2d also extend in the third direction D3 so as to connect the side surfaces 2e and 2f to each other. The side surfaces 2e and 2f extend in the second direction D2 so as to connect the main surfaces 2c and 2d to each other. The side surfaces 2e and 2f also extend in the first direction D1 so as to connect the end surfaces 2a and 2b to each other.

The main surface 2d is a mounting surface, for example, a surface facing another electronic device when the coil component 1 is mounted on another electronic device (not shown; for example, a circuit board or an electronic component). The end surfaces 2a and 2b are surfaces continuous from the mounting surface (that is, the main surface 2d).

In the present embodiment, the length of the element body 2 in the first direction D1 is larger than the length of the element body 2 in the second direction D2 and the length of the element body 2 in the third direction D3. The length of the element body 2 in the second direction D2 is larger than the length of the element body 2 in the third direction D3. In the present embodiment, the end surfaces 2a and 2b, the main surfaces 2c and 2d, and the side surfaces 2e and 2f have rectangular shapes. The length of the element body 2 in the first direction D1 may be equal to the length of the element body 2 in the second direction D2 and the length of the element body 2 in the third direction D3, or may be smaller than the length of the element body 2 in the second direction D2 and the length of the element body 2 in the third direction D3. In addition, in the present embodiment, “equal” may mean not only “exactly equal values” but also values including slight differences or manufacturing errors within a range set in advance. For example, a plurality of values are defined as being equal if these are within the range of ±5% of the average value of the plurality of values.

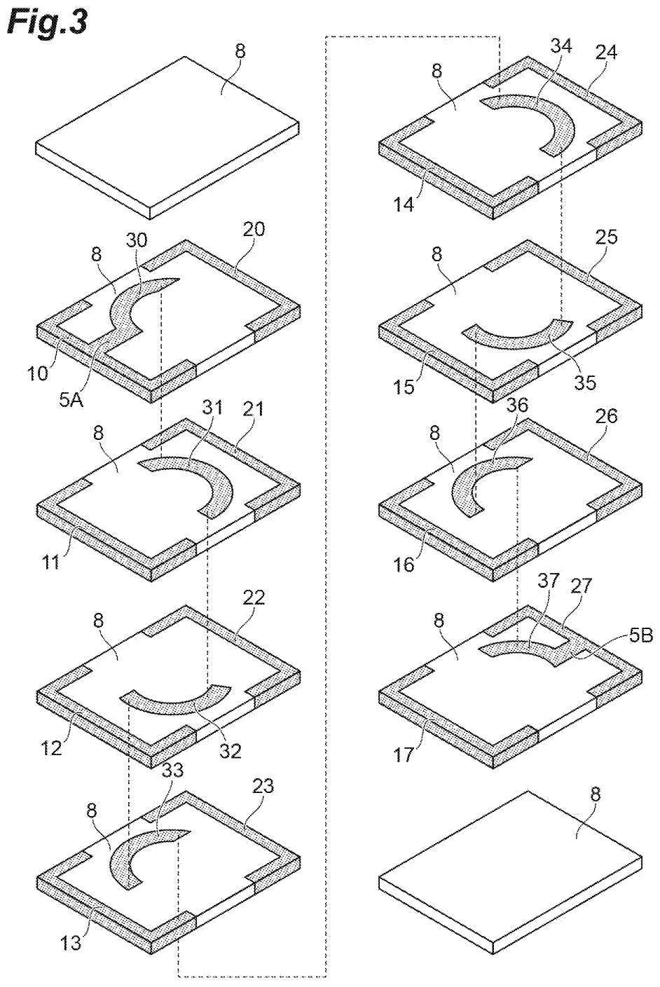

As shown in FIG. 3, the element body 2 is formed by stacking a plurality of element body layers 8 in the third direction D3. The element body 2 has a plurality of stacked element body layers 8. In the element body 2, the stacking direction of the plurality of element body layers 8 matches the third direction D3. Some of the element body layers 8 are formed integrally with the element body layers 8 adjacent to each other in the stacking direction, as will be described later.

Each element body layer 8 contains, for example, an insulating material. Each element body layer 8 contains, for example, a magnetic material as an insulating material. Examples of the magnetic material include an Ni—Cu—Zn-based ferrite material, an Ni—Cu—Zn—Mg-based ferrite material, an Ni—Cu-based ferrite material, and an Fe alloy. Each element body layer 8 may contain, for example, a non-magnetic material as an insulating material. Examples of the non-magnetic material include a glass ceramic material and a dielectric material. Each element body layer 8 is formed, for example, through a baking process for baking an insulating layer containing an insulating material, and may include a sintered body of the insulating material.

A first recessed portion 6 and a second recessed portion 7 are provided on the outer surface of the element body 2. Specifically, the first recessed portion 6 is provided on the end surface 2a, the main surface 2c, and the main surface 2d. The second recessed portion 7 is provided on the end surface 2b, the main surface 2c, and the main surface 2d.

The first terminal electrode 3 is arranged on the end surface 2a side of the element body 2. The second terminal electrode 4 is arranged on the end surface 2b side of the element body 2. The first terminal electrode 3 and the second terminal electrode 4 are spaced apart from each other in the second direction D2. The first terminal electrode 3 is arranged inside the first recessed portion 6. The second terminal electrode 4 is arranged inside the second recessed portion 7. The first terminal electrode 3 is arranged on the end surface 2a, the main surface 2c, and the main surface 2d. The second terminal electrode 4 is arranged on the end surface 2b, the main surface 2c, and the main surface 2d. In the present embodiment, the surface of the first terminal electrode 3 is approximately flush with each of the end surface 2a, the main surface 2c, and the main surface 2d. The surface of the second terminal electrode 4 is approximately flush with each of the end surface 2b, the main surface 2c, and the main surface 2d. The first terminal electrode 3 and the second terminal electrode 4 are formed of a conductive material (for example, Ag and/or Pd).

The first terminal electrode 3 has a channel shape (an approximately U shape or an approximately C shape) when viewed from the third direction D3. The first terminal electrode 3 has a first electrode portion 3A, a second electrode portion 3B, and a third electrode portion 3C. The first electrode portion 3A is arranged on the end surface 2a. The second electrode portion 3B is arranged on the main surface 2d. The third electrode portion 3C is arranged on the main surface 2c. The second electrode portion 3B and the third electrode portion 3C are arranged so as to face each other in the second direction D2.

The first electrode portion 3A and the second electrode portion 3B are connected at the ridge of the element body 2 to be electrically connected to each other. Specifically, an end 3Aa of the first electrode portion 3A on the main surface 2d side in the second direction D2 is connected to the second electrode portion 3B. The first electrode portion 3A and the third electrode portion 3C are connected at the ridge of the element body 2 and are electrically connected to each other. Specifically, an end 3Ab of the first electrode portion 3A on the main surface 2c side in the second direction D2 is connected to the third electrode portion 3C. In the present embodiment, the first electrode portion 3A, the second electrode portion 3B, and the third electrode portion 3C are integrally formed.

The first electrode portion 3A has a rectangular shape when viewed from the first direction D1. The first electrode portion 3A extends along each of the second direction D2 and the third direction D3. The second electrode portion 3B has a rectangular shape when viewed from the second direction D2. The second electrode portion 3B extends along each of the first direction D1 and the third direction D3. The third electrode portion 3C has a rectangular shape when viewed from the second direction D2. The third electrode portion 3C extends along each of the second direction D2 and the third direction D3. The first terminal electrode 3 is not exposed on the side surfaces 2e and 2f. That is, the element body 2 is arranged between the first electrode portion 3A, the second electrode portion 3B, and the third electrode portion 3C and the side surfaces 2e and 2f.

The first terminal electrode 3 is formed by stacking a plurality of first electrode layers 10, 11, 12, 13, 14, 15, 16, 17 (see FIG. 3) in the third direction D3. That is, the stacking direction of the first electrode layers 10 to 17 is the third direction D3. In the actual first terminal electrode 3, the plurality of first electrode layers 10 to 17 are integrated to such an extent that the boundaries between the layers cannot be visually recognized.

The second terminal electrode 4 has a channel shape (an approximately U shape or an approximately C shape) when viewed from the third direction D3. The second terminal electrode 4 has a first electrode portion 4A, a second electrode portion 4B, and a third electrode portion 4C. The first electrode portion 4A is arranged on the end surface 2b. The second electrode portion 4B is arranged on the main surface 2d. The third electrode portion 4C is arranged on the main surface 2c.

The first electrode portion 4A and the second electrode portion 4B are connected at the ridge of the element body 2 to be electrically connected to each other. Specifically, an end 4Aa of the first electrode portion 4A on the main surface (one main surface) 2d side in the second direction D2 is connected to the second electrode portion 4B. The first electrode portion 4A and the third electrode portion 4C are connected at the ridge of the element body 2 and are electrically connected to each other. Specifically, an end 4Ab of the first electrode portion 4A on the main surface (the other main surface) 2c side in the second direction D2 is connected to the third electrode portion 4C. In the present embodiment, the first electrode portion 4A, the second electrode portion 4B, and the third electrode portion 4C are integrally formed.

The first electrode portion 4A has a rectangular shape when viewed from the first direction D1. The first electrode portion 4A extends along each of the second direction D2 and the third direction D3. The second electrode portion 4B has a rectangular shape when viewed from the second direction D2. The second electrode portion 4B extends along each of the first direction D1 and the third direction D3. The third electrode portion 4C has a rectangular shape when viewed from the second direction D2. The third electrode portion 4C extends along each of the second direction D2 and the third direction D3. The second terminal electrode 4 is not exposed on the side surfaces 2e and 2f. That is, the element body 2 is arranged between the first electrode portion 4A, the second electrode portion 4B, and the third electrode portion 4C and the side surfaces 2e and 2f.

The second terminal electrode 4 is formed by stacking a plurality of second electrode layers 20, 21, 22, 23, 24, 25, 26, 27 (see FIG. 3) in the third direction D3. That is, the stacking direction of the second electrode layers 20 to 27 is the third direction D3. In the actual second terminal electrode 4, the plurality of second electrode layers 20 to 27 are integrated to such an extent that the boundaries between the layers cannot be visually recognized.

The first terminal electrode 3 and the second terminal electrode 4 may be subjected to electrolytic plating or electroless plating to form a plating layer (not shown) containing Ni, Sn, Au, or the like, for example. The plating layer may have, for example, an Ni plating film that contains Ni and covers the first terminal electrode 3 and the second terminal electrode 4 and an Au plating film that contains Au and covers the Ni plating film.

The coil 5 is arranged inside the element body 2. One end of the coil 5 is connected to the first terminal electrode 3 by a connection portion 5A. The other end of the coil 5 is connected to the second terminal electrode 4 by a connection portion 5B. The coil 5 has a circular outer shape when viewed from the third direction D3.

As shown in FIG. 3, the coil 5 includes a plurality of coil conductors 30, 31, 32, 33, 34, 35, 36, and 37. The plurality of coil conductors 30 to 37 are connected to each other to form the coil 5. A coil axis AX of the coil 5 is provided along the third direction D3. The coil conductors 30 to 37 are arranged so as to be spaced apart from the end surfaces 2a and 2b, the main surfaces 2c and 2d, and the side surfaces 2e and 2f. The coil 5 is formed of a conductive material (for example, Ag and/or Pd). The coil conductors 30 to 37 are formed so as to have a predetermined width.

The coil conductor 30 is connected to the first terminal electrode 3 through the connection portion 5A. The connection portion 5A is located in the same layer as the coil conductor 30. One end of the coil conductor 30 is connected to the connection portion 5A. The connection portion 5A connects the coil conductor 30 and the first electrode portion 3A of the first terminal electrode 3 to each other. The connection portion 5A may be connected to the second electrode portion 3B or the third electrode portion 3C. The coil conductor 30 and the connection portion 5A are integrally formed.

The coil conductor 31 is connected to the coil conductor 30. A part of the coil conductor 30 and a part of the coil conductor 31 overlap each other when viewed from the third direction D3. The coil conductor 32 is connected to the coil conductor 31. A part of the coil conductor 31 and a part of the coil conductor 32 overlap each other when viewed from the third direction D3. The coil conductor 33 is connected to the coil conductor 32. A part of the coil conductor 32 and a part of the coil conductor 33 overlap each other when viewed from the third direction D3. The coil conductor 34 is connected to the coil conductor 33. A part of the coil conductor 33 and a part of the coil conductor 34 overlap each other when viewed from the third direction D3.

The coil conductor 35 is connected to the coil conductor 34. A part of the coil conductor 34 and a part of the coil conductor 35 overlap each other when viewed from the third direction D3. The coil conductor 36 is connected to the coil conductor 35. A part of the coil conductor 35 and a part of the coil conductor 36 overlap each other when viewed from the third direction D3. The coil conductor 37 is connected to the coil conductor 36. A part of the coil conductor 36 and a part of the coil conductor 37 overlap each other when viewed from the third direction D3.

The coil conductor 37 is connected to the second terminal electrode 4 through the connection portion 5B. The connection portion 5B is located in the same layer as the coil conductor 37. One end of the coil conductor 37 is connected to the connection portion 5B. The connection portion 5B connects the coil conductor 37 and the first electrode portion 4A of the second terminal electrode 4 to each other.

The connection portion 5B may be connected to the second electrode portion 4B or the third electrode portion 4C. The coil conductor 37 and the connection portion 5B are integrally formed.

As shown in FIG. 2, the width of the first terminal electrode 3 may be equal to or less than the widths of the coil conductors 30 to 37. Specifically, the width W1 of the first electrode portion 3A, the width W2 of the second electrode portion 3B, and the width W3 of the third electrode portion 3C in the first terminal electrode 3 may be equal to or less than the width W4 of each of the coil conductors 30 to 37 (W1, W2, W3 W4). The width W1 of the first electrode portion 3A is the thickness of the first electrode portion 3A in the first direction D1. The width W1 of the first electrode portion 3A can also be said to be the thickness of the first electrode portion 3A when viewed from the third direction D3. The width W2 of the second electrode portion 3B is the thickness of the second electrode portion 3B in the second direction D2. The width W2 of the second electrode portion 3B can also be said to be the thickness of the second electrode portion 3B when viewed from the third direction D3. The width W3 of the third electrode portion 3C is the thickness of the third electrode portion 3C in the second direction D2. The width W3 of the third electrode portion 3D can also be said to be the thickness of the third electrode portion 3C when viewed from the third direction D3. In the present embodiment, the width W1 of the first electrode portion 3A, the width W2 of the second electrode portion 3B, and the width W3 of the third electrode portion 3C are equal (W1=W2=W3). Similarly, the width of the second terminal electrode 4 may be equal to or less than the widths of the coil conductors 30 to 37.

The widths of the connection portions 5A and 5B may be equal to or greater than the widths of the coil conductors 30 to 37. Specifically, the width W5 of the connection portion 5A and the width W6 of the connection portion 5B may be equal to or greater than the width W1 of each of the coil conductors 30 to 37 (W5, W6 W1).

A distance L1 between the end 3Ab (end surface) of the first electrode portion 3A of the first terminal electrode 3 and the main surface 2d is larger than a distance L2 between a top portion 5C of the coil 5 on the main surface 2c side (a portion of the coil 5 closest to the main surface 2c) and the main surface 2d (L1>L2). That is, the end 3Ab (end surface) of the first electrode portion 3A of the first terminal electrode 3 is located closer to the main surface 2c than the top portion 5C of the coil 5 on the main surface 2c side is. The top portion 5C of the coil 5 on the main surface 2c side is located closer to the main surface 2d than the end 3Ab (end surface) of the first electrode portion 3A of the first terminal electrode 3 is.

As described above, in the coil component 1 according to the present embodiment, in the second direction D2, the distance L1 between each of the ends 3Ab and 4Ab of the first electrode portions 3A and 4A on the main surface 2c side and the main surface 2d is larger than the distance L2 between the top portion 5C of the coil 5 closest to the main surface 2c and the main surface 2d (L1>L2). Therefore, in the coil component 1, the contact area between the element body 2 and the first terminal electrode 3 and the second terminal electrode 4 can be increased. For this reason, in the coil component 1, the bonding strength between the element body 2 and the first terminal electrode 3 and the second terminal electrode 4 can be improved. Therefore, in the coil component 1, the peeling of the first terminal electrode 3 and the second terminal electrode 4 from the element body 2 can be suppressed. As a result, it is possible to suppress deterioration in the reliability of the coil component 1.

In the coil component 1 according to the present embodiment, the first terminal electrode 3 and the second terminal electrode 4 have third electrode portions 3C and 4C that are connected to the ends 3Ab and 4Ab of the first electrode portions 3A and 4A on the main surface 2c side and are arranged opposite to the second electrode portion 3B and 4B in the second direction D2, respectively. With this configuration, the contact area between the element body 2 and the first terminal electrode 3 and the second terminal electrode 4 can be further increased. For this reason, in the coil component 1, the bonding strength between the element body 2 and the first terminal electrode 3 and the second terminal electrode 4 can be further improved. Therefore, in the coil component 1, the peeling of the first terminal electrode 3 and the second terminal electrode 4 from the element body 2 can be suppressed.

In the coil component 1 according to the present embodiment, the width W1 of the first electrode portion 3A, the width W2 of the second electrode portion 3B, and the width W3 of the third electrode portion 3C in the first terminal electrode 3 may be equal to or less than the width W4 of each of the coil conductors 30 to 37 (W1, W2, W3 W4). The width of the second terminal electrode 4 may also be equal to or less than the width W4 of the coil conductors 30 to 37. With this configuration, the volumes of the first terminal electrode 3 and the second terminal electrode 4 can be reduced. Therefore, in the process for manufacturing the coil component 1, it is possible to suppress the occurrence of cracks in the element body 2 due to the difference in thermal contraction rate between the element body 2 and the first terminal electrode 3 and the second terminal electrode 4.

In the coil component 1 according to the present embodiment, the coil 5 and the first electrode portion 3A of the first terminal electrode 3 are connected to each other by the connection portion 5A, and the coil 5 and the first electrode portion 4A of the second terminal electrode 4 are connected to each other by the connection portion 5B. The widths W5 and W6 of the connection portions 5A and 5B may be equal to or greater than the width W4 of the coil conductors 30 to 37. With this configuration, it is possible to improve the bonding strength between the first terminal electrode 3 and the connection portion 5A and the bonding strength between the second terminal electrode 4 and the connection portion 5B. Therefore, in the coil component 1, the peeling of the first terminal electrode 3 and the second terminal electrode 4 from the element body 2 can be suppressed.

In the coil component 1 according to the present embodiment, the coil 5 has a circular outer shape when viewed from the third direction D3. With this configuration, it is possible to secure the distance between the coil 5 and each of the first electrode portion 3A, the second electrode portion 3B, and the third electrode portions 3C of the first terminal electrode 3 and the distance between the coil 5 and each of the first electrode portion 4A, the second electrode portion 4B, and the third electrode portions 4C of the second terminal electrode 4.

Therefore, in the coil component 1, the stray capacitance generated between the first terminal electrode 3 and the second terminal electrode 4 and the coil 5 can be reduced.

### Second Embodiment

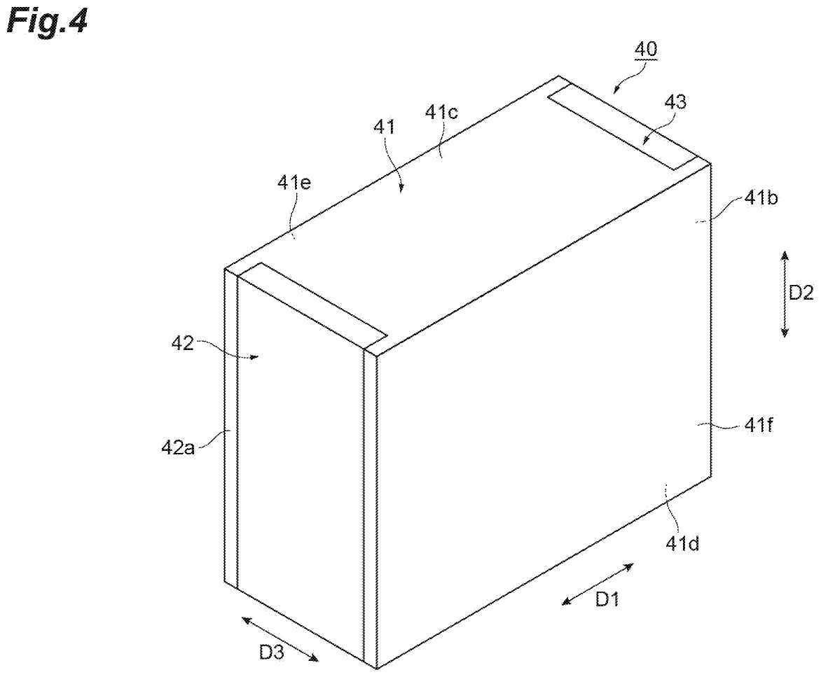

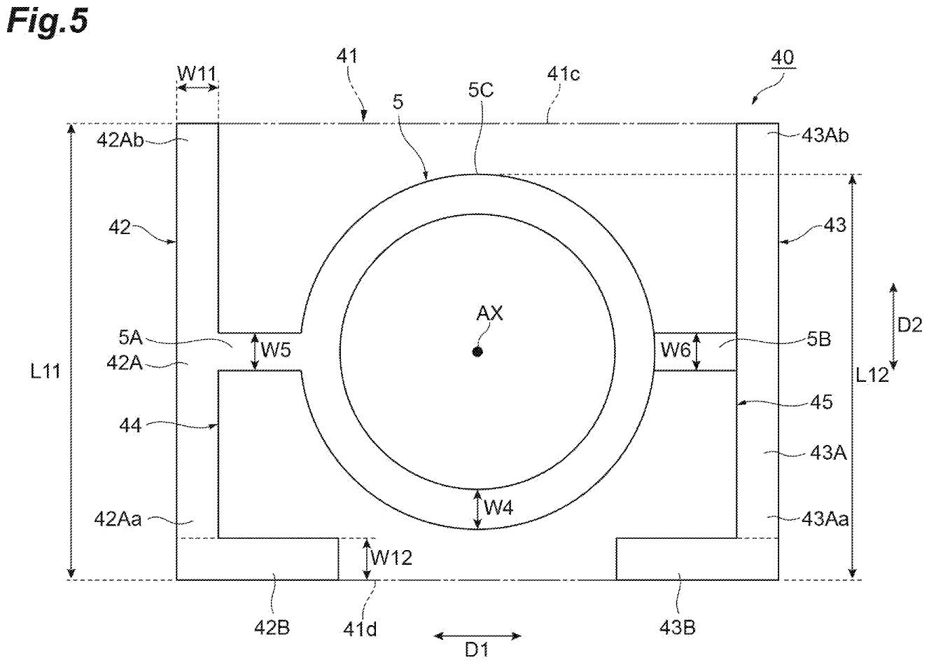

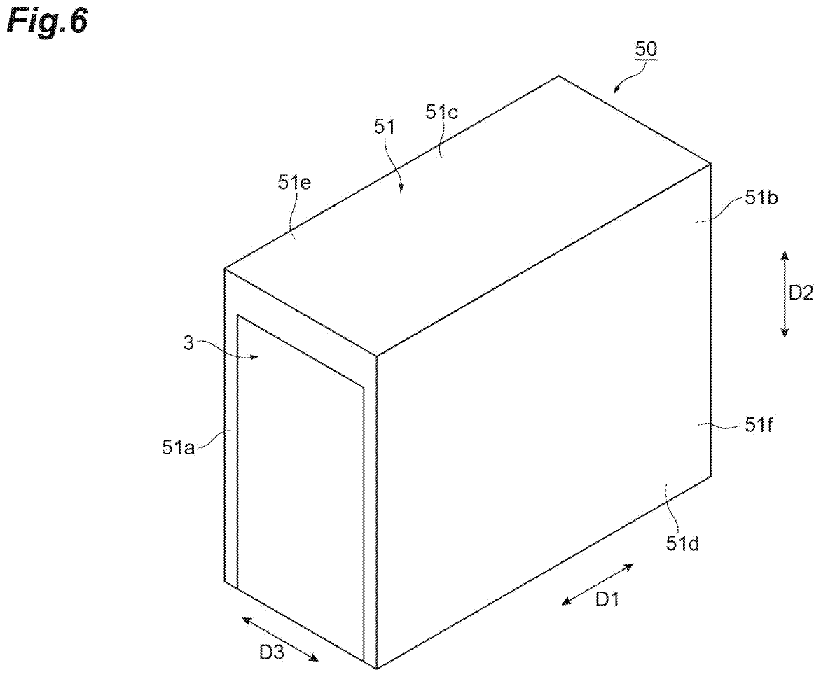

A coil component according to a second embodiment will be described with reference to FIGS. 4 and 5. FIG. 4 is a perspective view of the coil component according to the second embodiment. FIG. is a side view of the coil component shown in FIG. 4. In FIG. 6, an element body is indicated by a two-dot chain line.

As shown in FIGS. 4 and 5, a coil component 40 includes an element body 41, a first terminal electrode 42, a second terminal electrode 43, and a coil 5.

The element body 41 has a rectangular parallelepiped shape. The element body 41 has, as outer surfaces, end surfaces 41a and 41b, main surfaces 41c and 41d, and side surfaces 41e and 41f. The end surfaces 41a and 41b face each other. The main surfaces 41c and 41d face each other. The side surfaces 41e and 41f face each other. Hereinafter, it is assumed that a direction in which the end surfaces 41a and 41b face each other is a first direction D1, a direction in which the main surfaces 41c and 41d face each other is a second direction D2, and a direction in which the side surfaces 41e and 41f face each other is a third direction D3.

A first recessed portion 44 and a second recessed portion 45 are provided on the outer surface of the element body 41. Specifically, the first recessed portion 44 is provided on the end surface 41a and the main surface 41d. The second recessed portion 45 is provided on the end surface 41b and the main surface 41d.

The first terminal electrode 42 is arranged on the end surface 41a side of the element body 41. The second terminal electrode 43 is arranged on the end surface 41b side of the element body 41. The first terminal electrode 42 and the second terminal electrode 43 are spaced apart from each other in the second direction D2. The first terminal electrode 42 is arranged inside the first recessed portion 44. The second terminal electrode 43 is arranged inside the second recessed portion 45. The first terminal electrode 42 is arranged on the end surface 41a and the main surface 41d. The second terminal electrode 43 is arranged on the end surface 41b and the main surface 41d. In the present embodiment, the surface of the first terminal electrode 42 is approximately flush with each of the end surface 41a and the main surface 41d. The surface of the second terminal electrode 43 is approximately flush with each of the end surface 41b and the main surface 41d. The first terminal electrode 42 and the second terminal electrode 43 are formed of a conductive material (for example, Ag and/or Pd).

The first terminal electrode 42 has an L shape when viewed from the third direction D3. The first terminal electrode 42 has a first electrode portion 42A and a second electrode portion 42B. The first electrode portion 42A is arranged on the end surface 41a. The second electrode portion 42B is arranged on the main surface 41d.

The first electrode portion 42A and the second electrode portion 42B are connected at the ridge of the element body 41 to be electrically connected to each other. Specifically, an end 42Aa of the first electrode portion 42A on the main surface 41d side in the second direction D2 is connected to the second electrode portion 42B. In the present embodiment, the first electrode portion 42A and the second electrode portion 42B are integrally formed.

The first electrode portion 42A has a rectangular shape when viewed from the first direction D1. The first electrode portion 42A extends along each of the second direction D2 and the third direction D3. The second electrode portion 42B has a rectangular shape when viewed from the second direction D2. The second electrode portion 42B extends along each of the first direction D1 and the third direction D3. The first terminal electrode 42 is not exposed on the side surfaces 41e and 41f. That is, the element body 41 is arranged between the first electrode portion 42A and the second electrode portion 42B and the side surfaces 41e and 41f.

The second terminal electrode 43 has an L shape when viewed from the third direction D3. The second terminal electrode 43 has a first electrode portion 43A and a second electrode portion 43B. The first electrode portion 43A is arranged on the end surface 41b. The second electrode portion 43B is arranged on the main surface 41d.

The first electrode portion 43A and the second electrode portion 43B are connected at the ridge of the element body 41 to be electrically connected to each other. Specifically, an end 43Aa of the first electrode portion 43A on the main surface 41d side in the second direction D2 is connected to the second electrode portion 43B. In the present embodiment, the first electrode portion 43A and the second electrode portion 43B are integrally formed.

The first electrode portion 43A has a rectangular shape when viewed from the first direction D1. The first electrode portion 43A extends along each of the second direction D2 and the third direction D3. The second electrode portion 43B has a rectangular shape when viewed from the second direction D2. The second electrode portion 43B extends along each of the first direction D1 and the third direction D3. The second terminal electrode 43 is not exposed on the side surfaces 41e and 41f. That is, the element body 41 is arranged between the first electrode portion 43A and the second electrode portion 43B and the side surfaces 41e and 41f.

The coil 5 is arranged inside the element body 2. One end of the coil 5 is connected to the first terminal electrode 42 by a connection portion 5A. The other end of the coil 5 is connected to the second terminal electrode 43 by a connection portion 5B. The coil 5 has a circular outer shape when viewed from the third direction D3.

As shown in FIG. 6, the width of the first terminal electrode 42 may be equal to or less than the widths of the coil conductors 30 to 37 (see FIG. 3). Specifically, the width W11 of the first electrode portion 42A and the width W12 of the second electrode portion 42B in the first terminal electrode 42 may be equal to or less than the width W1 of each of the coil conductors 30 to 37 (W11, W12≤W1). In the present embodiment, the width W11 of the first electrode portion 42A and the width W12 of the second electrode portion 42B are equal (W11=W12). Similarly, the width of the second terminal electrode 43 may be equal to or less than the widths of the coil conductors 30 to 37.

A distance L11 between the end 42Aa (end surface) of the first electrode portion 42A of the first terminal electrode 42 and the main surface 41d is larger than a distance L12 between a top portion 5C of the coil 5 on the main surface 41c side (a portion of the coil 5 closest to the main surface 41c) and the main surface 41d (L11>L12). That is, the end 42Aa (end surface) of the first electrode portion 42A of the first terminal electrode 42 is located closer to the main surface 41c than the top portion 5C of the coil 5 on the main surface 41c side is. In other words, the top portion 5C of the coil 5 on the main surface 41c side is located closer to the main surface 41d than the end 42Aa (end surface) of the first electrode portion 42A of the first terminal electrode 42 is.

As described above, in the coil component 40 according to the present embodiment, in the second direction D2, the distance L11 between each of the ends 42Ab and 43Ab of the first electrode portions 42A and 43A on the main surface 41c side and the main surface 41d is larger than the distance L12 between the top portion 5C of the coil 5 closest to the main surface 41c and the main surface 41d (L11>L12). Therefore, in the coil component 40, the contact area between the element body 41 and the first terminal electrode 42 and the second terminal electrode 43 can be increased. For this reason, in the coil component 40, the bonding strength between the element body 41 and the first terminal electrode 42 and the second terminal electrode 43 can be improved. Therefore, in the coil component 40, the peeling of the first terminal electrode 42 and the second terminal electrode 43 from the element body 41 can be suppressed. As a result, it is possible to suppress deterioration in the reliability of the coil component 40.

### Third Embodiment

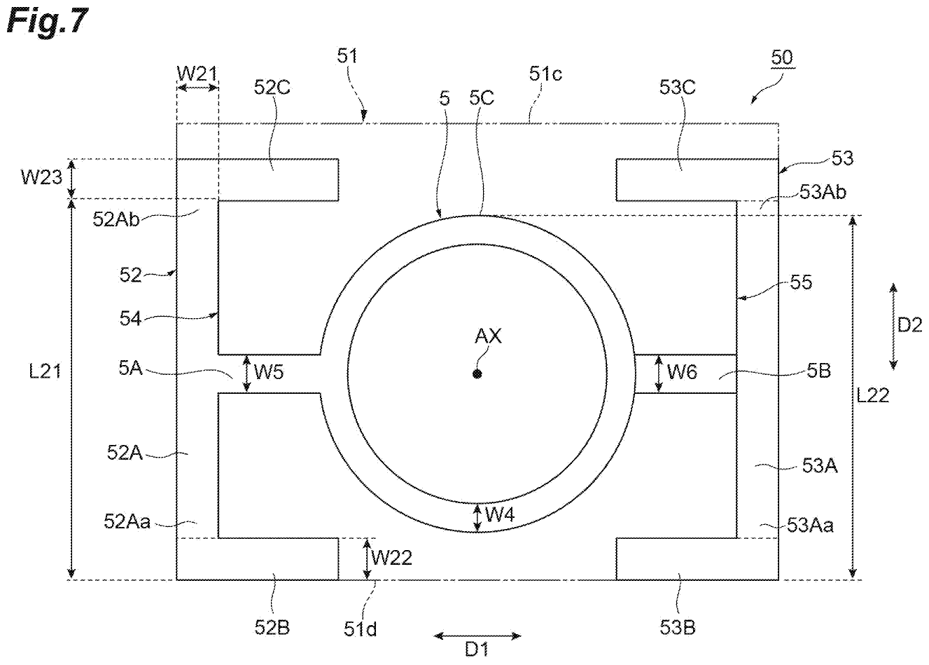

A coil component according to a third embodiment will be described with reference to FIGS. 6 and 7. FIG. 6 is a perspective view of the coil component according to the third embodiment. FIG. 7 is a side view of the coil component shown in FIG. 6. In FIG. 7, an element body is indicated by a two-dot chain line.

As shown in FIGS. 6 and 7, a coil component 50 includes an element body 51, a first terminal electrode 52, a second terminal electrode 53, and a coil 5.

The element body 51 has a rectangular parallelepiped shape. The element body 51 has, as outer surfaces, end surfaces 51a and 51b, main surfaces 51c and 51d, and side surfaces 51e and 51f. The end surfaces 51a and 51b face each other. The main surfaces 51c and 51d face each other. The side surfaces 51e and 51f face each other. Hereinafter, it is assumed that a direction in which the end surfaces 51a and 51b face each other is a first direction D1, a direction in which the main surfaces 51c and 51d face each other is a second direction D2, and a direction in which the side surfaces 51e and 51f face each other is a third direction D3.

A first recessed portion 54 and a second recessed portion 55 are provided on the outer surface of the element body 51. Specifically, the first recessed portion 54 is provided on the end surface 51a and the main surface 51d. The second recessed portion 55 is provided on the end surface 51b and the main surface 51d.

The first terminal electrode 52 is arranged on the end surface 51a side of the element body 51. The second terminal electrode 53 is arranged on the end surface 51b side of the element body 51. The first terminal electrode 52 and the second terminal electrode 53 are spaced apart from each other in the second direction D2. The first terminal electrode 52 is arranged inside the first recessed portion 54. The second terminal electrode 53 is arranged inside the second recessed portion 55. The first terminal electrode 52 is arranged on the end surface 52a and the main surface 52d. The second terminal electrode 53 is arranged on the end surface 52b and the main surface 51d. In the present embodiment, the surface of the first terminal electrode 52 is approximately flush with each of the end surface 51a and the main surface 51d. The surface of the second terminal electrode 53 is approximately flush with each of the end surface 51b and the main surface 51d.

The first terminal electrode 52 has a channel shape (an approximately U shape or an approximately C shape) when viewed from the third direction D3. The first terminal electrode 52 has a first electrode portion 52A, a second electrode portion 52B, and a third electrode portion 52C. The first electrode portion 52A is arranged on the end surface 51a. The second electrode portion 52B is arranged on the main surface 51d. The third electrode portion 52C is arranged inside the element body 51.

The first electrode portion 52A and the second electrode portion 52B are connected at the ridge of the element body 51 to be electrically connected to each other. Specifically, an end 52Aa of the first electrode portion 52A on the main surface 51d side in the second direction D2 is connected to the second electrode portion 52B. The first electrode portion 52A and the third electrode portion 52C are electrically connected to each other. Specifically, an end 52Ab of the first electrode portion 52A on the main surface 51c side in the second direction D2 is connected to the third electrode portion 52C. In the present embodiment, the first electrode portion 52A, the second electrode portion 52B, and the third electrode portion 52C are integrally formed.

The first electrode portion 52A has a rectangular shape when viewed from the first direction D1. The first electrode portion 52A extends along each of the second direction D2 and the third direction D3. The second electrode portion 52B has a rectangular shape when viewed from the second direction D2. The second electrode portion 52B extends along each of the first direction D1 and the third direction D3. The third electrode portion 52C has a rectangular shape when viewed from the second direction D2. The third electrode portion 52C extends along each of the second direction D2 and the third direction D3. The first terminal electrode 52 is not exposed on the side surfaces 51e and 51f. That is, the element body 51 is arranged between the first electrode portion 52A, the second electrode portion 52B, and the third electrode portion 52C and the side surfaces 51e and 51f.

The second terminal electrode 53 has a channel shape (an approximately U shape or an approximately C shape) when viewed from the third direction D3. The second terminal electrode 53 has a first electrode portion 53A, a second electrode portion 53B, and a third electrode portion 53C. The first electrode portion 53A is arranged on the end surface 51b. The second electrode portion 53B is arranged on the main surface 51d. The third electrode portion 53C is arranged inside the element body 51.

The first electrode portion 53A and the second electrode portion 53B are connected at the ridge of the element body 51 to be electrically connected to each other. Specifically, an end 53Aa of the first electrode portion 53A on the main surface 51d side in the second direction D2 is connected to the second electrode portion 53B. The first electrode portion 53A and the third electrode portion 53C are electrically connected to each other. Specifically, an end 53Ab of the first electrode portion 53A on the main surface 51c side in the second direction D2 is connected to the third electrode portion 53C. In the present embodiment, the first electrode portion 53A, the second electrode portion 53B, and the third electrode portion 53C are integrally formed.

The first electrode portion 53A has a rectangular shape when viewed from the first direction D1. The first electrode portion 53A extends along each of the second direction D2 and the third direction D3. The second electrode portion 53B has a rectangular shape when viewed from the second direction D2. The second electrode portion 53B extends along each of the first direction D1 and the third direction D3. The third electrode portion 53C has a rectangular shape when viewed from the second direction D2. The third electrode portion 53C extends along each of the second direction D2 and the third direction D3. The second terminal electrode 53 is not exposed on the side surfaces 51e and 51f. That is, the element body 51 is arranged between the first electrode portion 53A, the second electrode portion 53B, and the third electrode portion 53C and the side surfaces 51e and 51f.

The coil 5 is arranged inside the element body 2. One end of the coil 5 is connected to the first terminal electrode 52 by a connection portion 5A. The other end of the coil 5 is connected to the second terminal electrode 53 by a connection portion 5B. The coil 5 has a circular outer shape when viewed from the third direction D3.

As shown in FIG. 7, the width of the first terminal electrode 52 may be equal to or less than the widths of the coil conductors 30 to 37 (see FIG. 3). Specifically, the width W21 of the first electrode portion 52A, the width W22 of the second electrode portion 52B, and the width W23 of the third electrode portion 52C in the first terminal electrode 52 are equal to or less than the width W4 of each of the coil conductors 30 to 37 (W21, W22, W23≤W4). In the present embodiment, the width W21 of the first electrode portion 52A, the width W22 of the second electrode portion 52B, and the width W23 of the third electrode portion 52C are equal (W21=W22=W23). Similarly, the width of the second terminal electrode 53 may be equal to or less than the widths of the coil conductors 30 to 37.

A distance L21 between the end 52Ab (end surface) of the first electrode portion 52A of the first terminal electrode 52 and the main surface 51d is larger than a distance L22 between a top portion 5C of the coil 5 on the main surface 51c side (a portion of the coil 5 closest to the main surface 2c) and the main surface 51d (L21>L22). That is, the end 52Ab (end surface) of the first electrode portion 52A of the first terminal electrode 52 is located closer to the main surface 51c than the top portion 5C of the coil 5 on the main surface 51c side is. The top portion 5C of the coil 5 on the main surface 51c side is located closer to the main surface 51d than the end 52Ab (end surface) of the first electrode portion 52A of the first terminal electrode 52 is.

As described above, in the coil component 50 according to the present embodiment, in the second direction D2, the distance L21 between each of the ends 52Ab and 53Ab of the first electrode portions 52A and 53A on the main surface 51c side and the main surface 51d is larger than the distance L22 between the top portion 5C of the coil 5 closest to the main surface 51c and the main surface 51d (L21>L22). Therefore, in the coil component 50, the contact area between the element body 51 and the first terminal electrode 52 and the second terminal electrode 53 can be increased. For this reason, in the coil component 50, the bonding strength between the element body 51 and the first terminal electrode 52 and the second terminal electrode 53 can be improved. Therefore, in the coil component 50, the peeling of the first terminal electrode 52 and the second terminal electrode 53 from the element body 51 can be suppressed. As a result, it is possible to suppress deterioration in the reliability of the coil component 50.

In the coil component 50 according to the present embodiment, the third electrode portion 52C of the first terminal electrode 52 and the third electrode portion 53C of the second terminal electrode 53 are arranged inside the element body 51. For this reason, in the coil component 50, the bonding strength between the element body 51 and the first terminal electrode 52 and the second terminal electrode 53 can be further improved. Therefore, in the coil component 50, the peeling of the first terminal electrode 52 and the second terminal electrode 53 from the element body 51 can be further suppressed.

While the embodiments of the invention has been described above, the invention is not necessarily limited to the embodiments described above, and various changes can be made without departing from the scope of the invention.

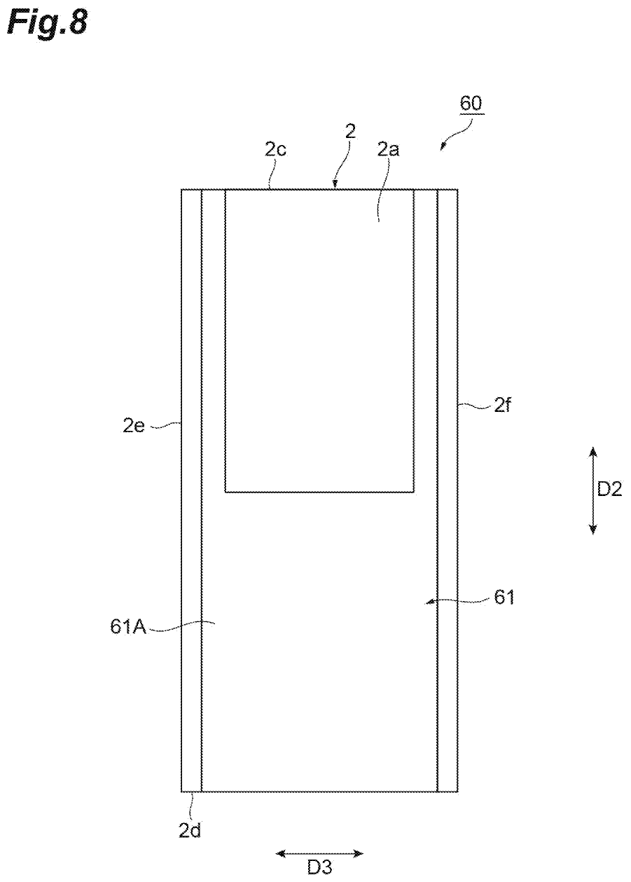

In the above embodiments, a form in which each of the first electrode portions 3A and 4A of the first terminal electrode 3 and the second terminal electrode 4 has a rectangular shape when viewed from the first direction D1 has been described as an example. However, as shown in FIG. 8, in a coil component 60, a first terminal electrode 61 (second terminal electrode) may have a recessed shape. In this configuration, in the second direction D2, a distance between the main surface 2d and an end of at least a part of a first electrode portion 61A, which is arranged on the end surface 2a of the element body 2, on the main surface 2c side is larger than a distance between a top portion of the coil 5 closest to the main surface 2c and the main surface 2d. Thus, it is sufficient that the distance between the main surface 2d and the end of at least a part of the first electrode portion 61A on the main surface 2c side is larger than the distance between the top portion of the coil 5 closest to the main surface 2c and the main surface 2d.

In the above embodiments, a form in which the first electrode portions 3A and 4A, the second electrode portions 3B and 4B, and the third electrode portions 3C and 4C of the first terminal electrode 3 and the second terminal electrode 4 are flush with the outer surface (the end surfaces 2a and 2b and the main surfaces 2c and 2d) of the element body 2 has been described as an example. However, the first electrode portions 3A and 4A, the second electrode portions 3B and 4B, and the third electrode portions 3C and 4C of the first terminal electrode 3 and the second terminal electrode 4 may protrude from the outer surface of the element body 2.

In the above embodiments, an example in which the coil 5 has a circular outer shape has been described. However, the coil 5 may have other outer shapes. In addition, the number of coil conductors forming the coil 5 is not limited to the value described above.

What is claimed is:

1. A coil component, comprising:
an element body having a pair of end surfaces facing each other, a pair of main surfaces facing each other, and a pair of side surfaces facing each other, one of the main surfaces being a mounting surface;
a coil arranged in the element body and formed by a plurality of coil conductors; and
a pair of terminal electrodes electrically connected to the coil,
wherein the coil has a coil axis extending in a direction in which the pair of side surfaces face each other,
each of the pair of terminal electrodes has a first electrode portion exposed on the end surface and a second electrode portion connected to an end of the first electrode portion on a side of the mounting surface and exposed on the mounting surface, and is not exposed on each of the pair of side surfaces, and
in a direction in which the pair of main surfaces face each other, a distance between the mounting surface and an end of at least a part of the first electrode portion on a side of the other main surface is larger than a distance between the mounting surface and a top portion of the coil closest to the other main surface.

2. The coil component according to claim 1,
wherein each of the pair of terminal electrodes has a third electrode portion that is connected to an end of the first electrode portion on the other main surface side and is arranged so as to face the second electrode portion in the direction in which the pair of main surfaces face each other.

3. The coil component according to claim 1,
wherein a thickness of the terminal electrode when viewed from the direction in which the pair of side surfaces face each other is equal to or less than a width of each of the plurality of coil conductors.

4. The coil component according to claim 1,
wherein the coil and the first electrode portion are connected to each other by a connection portion, and
a width of the connection portion is equal to or greater than a width of each of the plurality of coil conductors.

5. The coil component according to claim 2,
wherein the coil has a circular outer shape when viewed from the direction in which the pair of side surfaces face each other.
